(19) United States
(12) Patent Application Publication
(10) Pub. No.: US 2026/0077760 A1
(43) Pub. Date: Mar. 19, 2026

(54) Parking Space Detection Device and Method

(71) Applicants: Hyundai Motor Company, Seoul (KR); Kia Corporation, Seoul (KR)

(72) Inventors: Deuk Hyeon Kim, Hwaseong-Si (KR); Seok Beom Song, Hwaseong-Si (KR); Seong Wook Yoon, Hwaseong-Si (KR)

(21) Appl. No.: 19/052,447

(22) Filed: Feb. 13, 2025

(30) Foreign Application Priority Data
Sep. 13, 2024 (KR) 10-2024-0125242

(51) Int. Cl. B60W 30/06; G06T 7/20; G06V 20/56

(52) U.S. Cl. CPC B60W 30/06; G06T 7/20; G06V 20/588

(57) ABSTRACT

Provided is a device for detecting a parking space. The device may include one or more processors, and memory storing one or more instructions executable by the one or more processors to cause: receiving image data representing an external environment of a vehicle; determining, based on a plurality of image frames of the image data, a plurality of position changes of the vehicle; determining one or more base keypoints for a target parking space; determining, based on the one or more base keypoints and the plurality of position changes of the vehicle, one or more keypoints for the target parking space in each of the plurality of image frames; and controlling, based on the one or more keypoints, an autonomous parking operation of the vehicle.

### CROSS-REFERENCE TO RELATED APPLICATION

This application claims priority to and the benefit of Korean Patent Application No. 10-2024-0125242, filed on Sep. 13, 2024, the disclosure of which is incorporated herein by reference in its entirety.

### BACKGROUND

### Field

The present disclosure relates to a device and method for automated driving, and more specifically to autonomous parking services.

### Description

Parking spaces may be broadly classified as regular parking spaces and irregular parking spaces. In the case of regular parking spaces where parking lines are drawn along parking surfaces, a technique called keypoint labeling (also referred to as keypoint data labeling or keypoint annotation) may be utilized on parking lines and to perform deep learning in order to detect parking spaces.

However, in the case of irregular parking spaces where parking lines are not drawn or are only partially drawn on parking surfaces, it may be difficult to apply the above-described keypoint labeling. Further, when labeling is manually performed on irregular parking spaces, a problem may arise where the consistency of labeling is not maintained.

Consistent labeling may be important for achieving a desired level of performance of deep learning-based image recognition, and labeling that lacks such consistency may cause a decrease in the performance of deep learning.

Thus, in the case of irregular parking spaces, availability of autonomous parking services may be limited to parking spaces composed of, for example, objects having at least a specific height so that they can be detected by ultrasonic sensors.

### SUMMARY

The present disclosure is directed to providing a parking space detection device and method to automatically perform labeling on a parking space without parking lines.

According to one or more example embodiments of the present disclosure, a device may include one or more processors and memory. The memory may store one or more instructions executable by the one or more processors to cause: receiving image data representing an external environment of a vehicle; determining, based on a plurality of image frames, a plurality of position changes of the vehicle; determining one or more base keypoints for a target parking space; determining, based on the one or more base keypoints and the plurality of position changes of the vehicle, one or more keypoints for the target parking space in each of the plurality of image frames; and controlling, based on the one or more keypoints, an autonomous parking operation of the vehicle. The image data may be generated, by at least one camera associated with the vehicle, between a first time, when the vehicle starts a parking operation, and a second time, when the vehicle ends the parking operation. The image data may include the plurality of image frames. Each of the plurality of position changes may be a respective estimated position change of the vehicle between two frames of the plurality of image frames. The one or more base keypoints may be associated with the second time at which the vehicle is parked in the target parking space.

The one or more instructions may be executable by the one or more processors to cause the determining of the plurality of position changes of the vehicle by: determining, for each frame of the plurality of image frames in reverse order from the second time to the first time, a relative positional relationship between the one or more base keypoints and the vehicle. The one or more instructions may be executable by the one or more processors to cause the determining of the one or more keypoints by: determining, based on the relative positional relationship, the one or more keypoints in each of the plurality of image frames.

The one or more instructions may be executable by the one or more processors to cause the determining of the plurality of position changes by: determining the plurality of position changes further based on at least one of visual odometry or visual inertial odometry.

The one or more instructions may be executable by the one or more processors to further cause: determining, based on the image data and sensing data, a road profile of a ground around the vehicle. The sensing data may be generated, at the second time, by a lidar sensor.

The one or more instructions may be executable by the one or more processors to cause the determining of the road profile by: determining, based on the image data and the sensing data, a relative height, relative to a first ground surface in the target parking space, of a second ground surface outside the target parking space.

The one or more instructions may be executable by the one or more processors to further cause: adjusting, based on the road profile, a position change, of the plurality of position changes, that is associated with the second time.

The one or more instructions may be executable by the one or more processors to cause the determining of the one or more base keypoints by: determining the one or more base keypoints along a virtual shape surrounding the vehicle, the virtual shape having a point of origin at a center of the vehicle.

The one or more instructions may be executable by the one or more processors to cause the determining of the one or more base keypoints by: determining the one or more base keypoints at vertexes of the virtual shape.

The one or more instructions may be executable by the one or more processors to cause the determining of the one or more base keypoints by: determining the one or more base keypoints further based on at least one of a length of the vehicle and a width of the vehicle.

The one or more instructions may be executable by the one or more processors to further cause: determining, based on sensing data received from an ultrasonic sensor, margin values; and adjusting, based on the margin values, the one or more base keypoints.

At the first time, the target parking space may be photographed by the at least one camera. At the second time, the vehicle may be located in and aligned to the target parking space.

The target parking space may have less than four boundary lines.

According to one or more example embodiments of the present disclosure, a method performed by a computing device of a vehicle may include: receiving image data representing an external environment of the vehicle; determining, based on a plurality of image frames, a plurality of position changes of the vehicle; determining one or more base keypoints for a target parking space; determining, based on the one or more base keypoints and the plurality of position changes of the vehicle, one or more keypoints for the target parking space in each of the plurality of image frames; and controlling, based on the one or more keypoints, an autonomous parking operation of the vehicle. The image data may be generated, by at least one camera associated with the vehicle, between a first time, when the vehicle starts a parking operation, and a second time, when the vehicle ends the parking operation. The image data may include the plurality of image frames. Each of the plurality of position changes may be a respective estimated position change of the vehicle between two frames of the plurality of image frames. The one or more base keypoints may be associated with the second time at which the vehicle is parked in the target parking space.

Determining the plurality of position changes of the vehicle may include: determining, for each frame of the plurality of image frames in reverse order from the second time to the first time, a relative positional relationship between the one or more base keypoints and the vehicle. Determining the one or more keypoints may include: determining, based on the relative positional relationship, the one or more keypoints in each of the plurality of image frames.

The method may further include: determining, based on the image data and sensing data, a road profile of a ground around the vehicle. The sensing data may be generated, at the second time, by a lidar sensor; and adjusting, based on the road profile, a position change, of the plurality of position changes, that is associated with the second time.

Determining the road profile may include: determining, based on the image data and the sensing data, a relative height, relative to a first ground surface in the target parking space, of a second ground surface outside the target parking space.

Determining the one or more base keypoints may include: determining the one or more base keypoints along a virtual shape surrounding the vehicle, the virtual shape having a point of origin at a center of the vehicle.

Determining the one or more base keypoints may include: determining the one or more base keypoints at vertexes of the virtual shape.

Determining the one or more base keypoints may include: determining the one or more base keypoints further based on at least one of a length of the vehicle and a width of the vehicle.

The method may further include: determining, based on sensing data received from an ultrasonic sensor, margin values; and adjusting, based on the margin values, the one or more base keypoints.

### BRIEF DESCRIPTION OF THE DRAWINGS

The above and other objects, features, and advantages of the present disclosure will become more apparent to those of ordinary skill in the art by describing one or more example embodiments thereof in detail with reference to the accompanying drawings, in which:

FIG. 1 is a conceptual diagram of a vehicle;

FIG. 2 is a configuration block diagram of a parking space detection device;

FIG. 3 is a conceptual diagram for describing parking spaces;

FIG. 4, FIG. 5, FIG. 6, and FIG. 7 are views for describing operations of a parking space detection device; and

FIGS. 8 and 9 are flowcharts of one or more example parking space detection methods.

### DETAILED DESCRIPTION

Hereinafter, one or more example embodiments of the present disclosure will be described in detail with reference to the accompanying drawings.

However, it should be understood that the technical spirit of the present disclosure is not limited to the example embodiments as disclosed herein but may be implemented in many different forms. It should be understood that within the scope of the present disclosure, one or more elements of each of the example embodiments may be selectively combined and substituted.

In addition, terms (including technical and scientific terms) used in the example embodiments of the present disclosure have the same meanings as commonly understood by one of ordinary skill in the art to which the present disclosure belongs. It should be further understood that terms, such as those defined in commonly used dictionaries, should be interpreted as having meanings that are consistent with their meanings in the context of the related field(s).

Further, the terms used in the example embodiments of the present disclosure are provided only to describe the example embodiments and not for purposes of limitation.

In this specification, the singular forms include the plural forms unless the context clearly indicates otherwise, and the phrase “at least one element (or one or more elements) of an element A, an element B, and an element C,” should be understood as including the meaning of at least one of all combinations being obtained by combining the element A, the element B, and the element C. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

Further, in describing elements of the present disclosure, terminologies such as “first,” “second,” “A,” “B,” “(a),” and “(b)” may be used.

These terms are used to distinguish an element from another element, but a nature, an order, or a sequence of the elements is not limited by the terminology.

It will be understood that when an element is referred to as being “connected” or “coupled” to another element, it can be directly connected or coupled to another element, intervening elements may be present, or it can be connected or coupled to another element through still another element.

Further, when an element is described as being formed “on (above)” or “under (below)” another element, the term “on (above)” or “under (below)” includes both of a case in which the two elements are in direct contact with each other or a case in which one or more elements are (indirectly) disposed between the two elements. In addition, the term “on (above)” or “under (below)” includes a case in which one element is disposed in an upward direction or a downward direction with respect to the other element.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., generating keypoints based on parking image analysis) described herein, an operation of the vehicle may be controlled (e.g., autonomous parking). The vehicle control may include various operational controls associated with the vehicle (e.g., autonomous driving control, autonomous parking, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., generating keypoints based on parking image analysis) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., generating keypoints based on parking image analysis) described herein.

Minimum risk maneuver (MRM) operation(s) may also be controlled, for example, based on one or more features (e.g., generating keypoints based on parking image analysis) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., generating keypoints based on parking image analysis) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., inertial measurement unit (IMU) sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., generating keypoints based on parking image analysis) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

Based on the keypoints, an operation of the vehicle may be controlled. For example, an operation of the vehicle may be controlled based on an artificial intelligence algorithm, such as a deep learning model. The keypoints may be applied to train a deep learning model. The deep learning model that is trained in this manner (especially over a period of time and across multiple parking operations) may be used for the vehicle to detect one or more parking spaces. The vehicle may detect parking spaces (e.g., irregular parking spaces) to perform, for example, an autonomous parking operation.

Hereinafter, one or more example embodiments will be described in detail with reference to the accompanying drawings, the same or corresponding components are denoted by the same reference numerals regardless of reference numbers, and thus the description thereof will not be repeated.

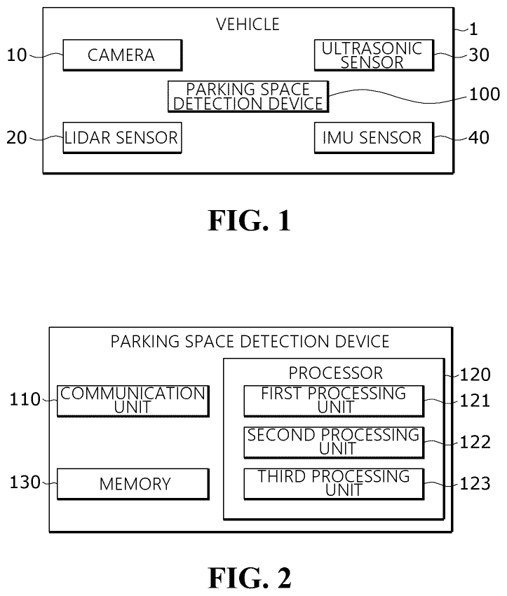

FIG. 1 is a conceptual diagram of a vehicle. One or more components shown in FIG. 1 may have different functions and capabilities from those described below, and additional components other than those described herein may be added. Further, each component may be implemented using one or more physically separated devices, or may be implemented by one or more processors or a combination of one or more processors and software, and may not be clearly distinguished in its specific operation, unlike the illustrated examples.

A parking space detection device 100 may be integrated with a vehicle or implemented as a separate device and mounted in the vehicle.

The parking space detection device 100 may be implemented in a logic circuit by hardware, firmware, software, or a combination thereof and may be implemented using a general-purpose or special-purpose computer. The parking space detection device 100 may be implemented using a hardwired device, a field-programmable gate array (FPGA), an Application-Specific Integrated Circuit (ASIC), etc. Further, the parking space detection device 100 may be implemented as a system on chip (SoC) including one or more processors and a controller.

In addition, the parking space detection device 100 may be mounted in a computing device or server equipped with hardware elements in the form of software, hardware, or a combination thereof. The computing device or server may be various devices that include all or some of various types of devices for performing communication with various devices or wired/wireless communication networks, such as a communication modem or the like, a memory for storing data for executing a program, a microprocessor for executing the program to perform calculations and instructions, and the like.

A camera 10, a lidar sensor 20, and an ultrasonic sensor 30 may be provided in the vehicle 1 to detect external objects, road surfaces, etc.

The camera 10 mounted in the vehicle 1 is a module for capturing images of a vehicle in all directions (front, rear, left, and right) and may include a front camera, a rear camera, a left-side camera, and a right-side camera.

The camera 10 may include an image sensor and an image processing module, and the image sensor may include at least one of a complementary metal-oxide-semiconductor (CMOS) and a charge-coupled device (CCD).

The lidar sensor 20 may irradiate the object with laser pulses, then measure a time for which the laser pulses return after being reflected from the object within a measurement range, and obtain information such as a distance to the object, a direction of the object, a speed of the object, etc. Here, the object may be another vehicle, a person, a thing, etc. that are present outside the vehicle.

The lidar sensor 20 may be mounted in a front of the vehicle 1 (e.g., inside a front bumper), may irradiate the road surface with laser pulses and receive reflected laser pulses to sense the road surface. At least one lidar sensor 20 may be installed on a front surface of the vehicle 1. For example, the lidar sensor 20 may irradiate each layer of the road surface on which the vehicle 1 is traveling with laser pulses and measure a time for which the radiated laser pulses return after being reflected from each layer. Further, the lidar sensor 20 may scan the road to sense the condition of the road (e.g., whether the road is a straight road).

The lidar sensor 20 may irradiate the road surface with laser pulses at a certain angle interval with respect to a horizontal direction and detect laser pulses returning after being reflected from each layer of the road. For example, the lidar sensor 20 may irradiate the road surface with laser pulses at a 0.5° interval with respect to the horizontal direction.

Further, a plurality of ultrasonic sensors 30 may be provided in the vehicle 1. The ultrasonic sensors 30 may detect objects located around the vehicle 1. A front ultrasonic sensor may obtain frontal ultrasonic data by emitting ultrasonic waves forward from the vehicle and receiving echoing ultrasonic signals reflected from objects located forward. A corner ultrasonic sensor may obtain corner ultrasonic data by emitting ultrasonic waves in a corner direction from the vehicle and receiving echoing ultrasonic signals reflected from objects located in the corner direction. A rear ultrasonic sensor may obtain rear ultrasonic data by emitting ultrasonic waves rearward from the vehicle and receiving echoing ultrasonic signals reflected from objects located rearward.

Further, the vehicle 1 may be equipped with an inertial measurement unit (IMU) sensor 40. The IMU sensor 40 may measure acceleration and angular velocity that represent the action of the vehicle 1. The IMU sensor 40 may include a triaxial accelerometer and a triaxial angular velocity meter and measure acceleration in a traveling direction X of the vehicle 1, acceleration in a lateral direction Y, acceleration in a height direction Z as well as a yaw, a pitch, and roll trajectories as the angular velocity of the vehicle.

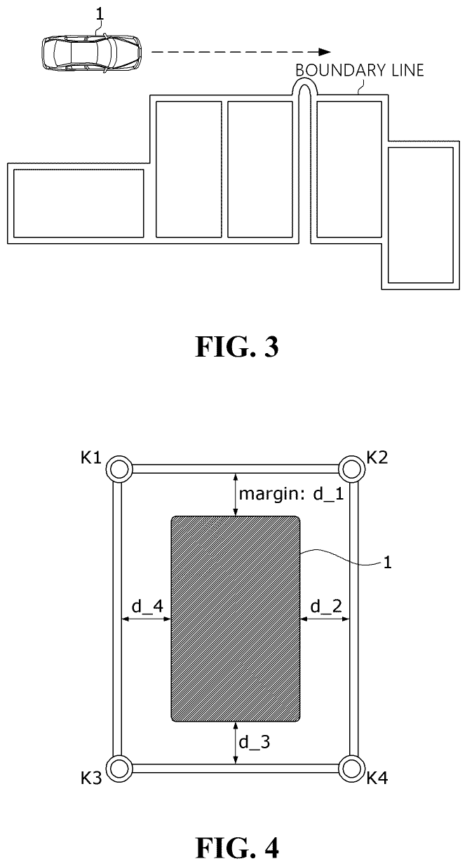

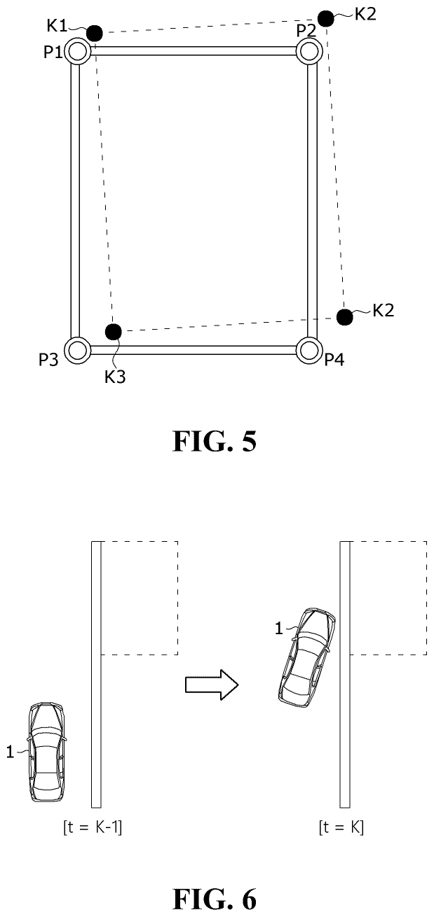

FIG. 2 is a configuration block diagram of the parking space detection device, and FIG. 3 is a conceptual diagram for describing an operation of the parking space detection device.

Referring to FIG. 2, the parking space detection device 100 may include a communication unit 110, a processor 120, and a memory 130. The processor 110 of the vehicle control apparatus 100 may include hardware components for processing data based on executing one or more instructions (e.g., computer-readable instructions, code, a program, etc.). The hardware components for processing data may include one or more of, for example, an arithmetic and logic unit (ALU), a floating-point unit (FPU), a field-programmable gate array (FPGA), a central processing unit (CPU), a microcontroller unit (MCU), an application-specific integrated circuit (ASIC), an application processor (AP) and/or a graphics processing unit (GPU). The processor 110 may consist of one or more processors or processor cores. For example, the processor 110 may have the structure of a multi-core processor. For example, the processor 110 may be a dual core processor, a quad-core processor, a hexa-core processor, an octa-core processor, etc.

Further, the processor 120 may include a first processing unit 121, a second processing unit 122, and a third processing unit 123. One or more of the various components shown in FIG. 2 may be combined or be further subdivided. For example, the processing unit 121, the second processing unit 122, and the third processing unit 123 of the processor 120 may be combined into a fewer quantity of processing unit(s), or alternatively, additional processing unit(s) may be added to the processor 120. The various functions, tasks, and operations as described herein as being performed by one or more of the processing unit 121, the second processing unit 122, and the third processing unit 123 may be performed by any one single processing unit, by any one or two of the other processing units, by the processor 120 as a whole, or by any one or more additional processing units not shown in FIG. 2. For example, one or more functions, tasks, and operations as described herein as being performed by the first processing unit 121 may be performed either by the second processing unit 122 alone, by the third processing unit 123 alone, by the processor 120 as a whole, or by any one or more additional processing units not shown in FIG. 2. For example, one or more functions, tasks, and operations as described herein as being performed by the second processing unit 122 may be performed either by the first processing unit 121 alone, by the third processing unit 123 alone, by the processor 120 as a whole, or by any one or more additional processing units not shown in FIG. 2. For example, one or more functions, tasks, and operations as described herein as being performed by the third processing unit 123 may be performed either by the first processing unit 121 alone, by the second processing unit 122 alone, by the processor 120 as a whole, or by any one or more additional processing units not shown in FIG. 2.

The communication unit 110 may support the parking space detection device 100 to communicate with an electronic control unit (ECU) and sensors that are mounted in the vehicle 1. The communication unit 110 may include a transceiver that transmits or receives controller area network (CAN) messages using a CAN protocol. Further, the communication unit 110 may support communication with the parking space detection device 100. The communication unit 110 may include a wireless communication circuit and/or a wired communication circuit.

The communication unit 110 may communicate with the camera 10, the lidar sensor 20, and the ultrasonic sensor 30 that are mounted in the vehicle 1 and receive image data of the camera 10, first sensing data of the lidar sensor 20, and second sensing data of the ultrasonic sensor 30.

Further, the communication unit 110 may receive third sensing data from the IMU sensor 40 (e.g., accelerometer(s) and/or gyro(s)) of the vehicle 1.

The memory 130 may be a non-transitory storage medium for storing instructions executed by the first to third processing units 121 to 123. The memory 130 may include at least one of storage media, such as a random access memory (RAM), a static RAM (SRAM), a read-only memory (ROM), a programmable ROM (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS), and/or a web storage.

Further, the memory 130 may perform a data logging function. The memory 130 may include a buffer in which a parking start time point and a parking end time point are recorded according to the operation of the processor. The parking start time point may be a time when the vehicle 1 starts a parking operation. The parking end time point may be a time when the vehicle 1 ends (e.g., completes) the parking operation. Further, the memory 130 may be configured to store data required for the operation of the processor and store result data output according to the operation of the processor.

The parking start time point may be a time point at which a target parking space is photographed by at least one camera 10, and the parking end time point may be a time point at which the vehicle 1 is completely arranged in the target parking space (e.g., the vehicle 1 is placed in and aligned to the target parking space). The target parking space may be a space surrounding the vehicle 1 when the parking is completed and may be a rectangular space.

The target parking space may be a space having less than four boundary lines surrounding (e.g., bordering) the parking space, but the present disclosure is not limited thereto. In the case of regular parking spaces (also referred to as regulated parking spaces, marked parking spaces, or designated parking spaces), the parking space may be defined through four boundary lines surrounding the parking space. That is, a parking space entrance line, a parking space exit line, and two side lines connecting the parking space entrance line and the parking space exit line.

However, there are cases where a parking operation is performed in a space with three or fewer boundary lines or a space without any boundary lines. In the present disclosure, although an example of an irregular parking space (also referred to as an unregulated parking space, an unmarked parking space, or a designated parking space) having less than four parking boundary lines is described, the present disclosure is not limited thereto, and the present disclosure may be applied to a regular parking space with four parking boundary lines.

The parking start time point may be recorded as a time point at which the target parking space is photographed by at least one camera 10. The target parking space may be determined by the processor 120, and the processor 120 may define a first time point at which image data obtained by photographing the target parking space is received from the camera as the parking start time point and record the first time point in the memory 130. The parking of the vehicle when the photographing takes place may be performed by a human operator (e.g., a human driver) or autonomously without any human intervention.

Alternatively, the parking start time point may be determined by a driver. The driver may check an image captured by the camera 10 through audio-visual navigation (AVN) and operate an interface so that a time point at which image data of a space determined to be the target parking space is checked is recorded as the parking start time point.

Alternatively, the parking start time point may be determined by a deep learning model included in the processor 120. The deep learning model may learn the image data obtained by photographing the target parking space and logging data in which the parking start time point is recorded. The deep learning model may realize a learning model by repeatedly learning the image data and the logging data. The implemented learning model may define the parking start time point when the data of the image captured by the camera 10 is input and record the parking start time point in the memory 130.

The parking end time point may be a time point at which the parking of the vehicle 1 is completed in the target parking space. The parking end time point may be recorded by manual input by the driver or may be recorded as a time point at which the engine of vehicle 1 is turned off, a parking brake of the vehicle 1 is turned on, etc.

Alternatively, the parking end time point may be determined by a deep learning model included in the processor 120. The deep learning model may learn the image data obtained by photographing the target parking space and logging data in which the parking end time point is recorded. The deep learning model may realize a learning model by repeatedly learning the image data and the logging data. The implemented learning model may define the parking end time point when the data of the image captured by the camera 10 is input and record the parking end time point in the memory 130.

The first processing unit 121 may analyze image data for surrounding images of the vehicle captured by the camera between the parking start time point and the parking end time point to estimate a change in position of the vehicle between frames of the image data. In other words, first processing unit 121 may receive image data that represents an external environment of a vehicle. The image data may be generated, for example, by a camera associated with the vehicle. The image data may be generated, for example, between a first time when the vehicle starts a parking operation and a second time when the vehicle ends the parking operation. The image data may include one or more image frames. The first processing unit 121 may determine, based on the image frames, position changes of the vehicle. Each position change may be a respective estimated position change of the vehicle between two consecutive frames of the image frames. In other words, the position changes may be a series of estimations of the vehicle's position changes from the first image frame to the last image frame. The first processing unit 121 may estimate the change in position of the vehicle by calculating the movement of the vehicle between the image frames. The first processing unit 121 may estimate the change in position of the vehicle for each frame of all the image data from a time point t=0, which is the parking start time point, to a time point t=T, which is the parking end time point.

For example, the first processing unit 121 may estimate the change in position of the vehicle using visual odometry (VO) or visual inertial odometry (VIO).

Odometry may refer to a system or method for measuring a position of a vehicle within a world reference frame and a speed at which the vehicle moves within the world reference frame. The first processing unit 121 may generate odometry information using one or more estimates (e.g., measurements) of the characteristics of the vehicle within the world reference frame. For example, the first processing unit 121 may generate the odometry information using the third sensing data received from the IMU sensor and the image data of the camera to estimate the change in position of the vehicle.

Referring to FIG. 3 together, the first processing unit 121 may gradually estimate the position of the vehicle through changes that occur in the image frames of the mounted camera due to the movement of the vehicle. The first processing unit 121 may calculate acceleration of the vehicle in the traveling direction X, acceleration in the lateral direction Y, acceleration in the height direction Z as well as a yaw, a pitch, and roll trajectories as the angular velocity of the vehicle for each frame from the parking start time point to the parking end time point of the vehicle to calculate the change in position of the vehicle.

Although FIG. 3 is described as a conceptual diagram in the form of a top view for convenience of description, the change in position of the vehicle may be estimated by utilizing the image data obtained from the front camera, the side cameras, and the rear camera for each frame in actual camera image data.

Alternatively, the first processing unit 121 may calculate the change in position of the vehicle using the odometry information according to the movement of the vehicle. The odometry information may be obtained from a wheel speed sensor and a yaw rate sensor for the third sensing data, and the first processing unit 121 may estimate the change in position of the vehicle using a value obtained from the wheel speed sensor and a value obtained from the yaw rate sensor. The change in position of the vehicle may be estimated as provided in the following Equation 1.

$$[ \begin{matrix}{x}^{′} \\ {y}^{′} \\ {θ}^{′}\end{matrix} ] = [ \begin{matrix}x + ρ cos ( θ k ) \\ y + ρ sin ( θ k ) \\ θ k\end{matrix} ] \qquad [ Equation 1 ]$$

In Equation 1, x and y denote the positions of the vehicle at previous time point t=k−1, x′ and y′ denote the positions of the vehicle at current time point t=k, p denotes a distance traveled by the vehicle, and θ denotes a rotation angle (yaw). The distance by the vehicle and the rotation angle may be calculated from the third sensing data obtained from the IMU sensor.

The first processing unit 121 may have an error with respect to the change in position of the vehicle estimated using the odometry information. Therefore, the first processing unit 121 may correct the change in position of the vehicle using the image data of the camera. The IMU sensor usually has an update rate of at least 100 Hz. Therefore, when the IMU sensor is used together with a camera having a rate of 30 Hz/60 Hz, a plurality of pieces of sensing data of the IMU sensor are obtained between image frames of the camera.

In this case, by integrating the linear acceleration and angular velocity of the third sensing data, a rotation value and a movement value may be calculated. The IMU sensor generates sensor noise due to having its own independent structure, noise increases as the integration process progresses, and errors may occur in an estimate of the change in position of the vehicle due to values of the increased noise.

The first processing unit 121 may calculate the acceleration of the vehicle in the traveling direction X, the acceleration in the lateral direction Y, the acceleration in the height direction Z as well as a yaw, a pitch, and roll trajectories as the angular velocity of the vehicle for each frame from the parking start time point of the vehicle to the parking end time point to calculate the change in position of the vehicle and may use the calculated change in position of the vehicle to correct the value of the change in position of the vehicle calculated in Equation 1. In this way, when a number of errors accumulate while the change in position of the vehicle is estimated using the IMU sensor, the value of the change in position of the vehicle may be corrected with an accurate value of the change in position of the vehicle estimated using the camera.

The first processing unit 121 may estimate a road profile of the ground around the vehicle at the parking end time point using the image data and the first sensing data generated from the lidar sensor. For example, the first processing unit 121 may estimate the height of the ground around the target parking space using the image data and the first sensing data to generate the road profile. The road profile may include topographical information associated with the ground surfaces around or outside the target parking space (e.g., an area within a threshold distance away from the target parking space). The road profile may, for example, indicate a relative height (or relative elevation) of one or more surface locations around the target parking space. The relative height or relative elevation may be measured relative to a ground surface of the target parking space (e.g., a specific point within the target parking space).

The first processing unit 121 may correct the change in position of the vehicle at the parking end time point using the road profile.

The first processing unit 121 may analyze data scanned by the lidar sensor to determine the condition of the ground on which the vehicle is traveling. When the parking end time point is recorded, the first processing unit 121 may control the lidar sensor to irradiate the ground of the target parking space with laser pulses, calculate a distance between the lidar sensor and the ground using detection information received from the radar sensor, and estimate the height of the ground using the calculated distance.

The first processing unit 121 may use the road profile to correct the change in position of the vehicle according to the height of the ground and accurately detect the target parking space at the parking end time point.

The second processing unit 122 may generate base keypoints at a plurality of points around the target parking space in which the vehicle is parked at the parking end time point. Base keypoints may be points (e.g., predetermined) points on an object or an area that can be used as reference points to keep track of the object or the area. For example, the base keypoints may be used as reference points to determine the position of the target parking space. The second processing unit 122 may determine one or more base keypoints for the target parking space. The one or more base keypoints may be associated with the parking end time point, at which the vehicle is parked in the target parking space. The second processing unit 122 may generate the base keypoints along a virtual shape surrounding (e.g., enveloping, encasing, etc.) the vehicle with the center of the vehicle as the point of origin. The second processing unit 122 may generate the base keypoints at vertexes of the virtual shape. For example, the second processing unit 122 may define a virtual rectangular shape forming the target parking space and generate four vertexes of the defined virtual rectangular shape as the base keypoints.

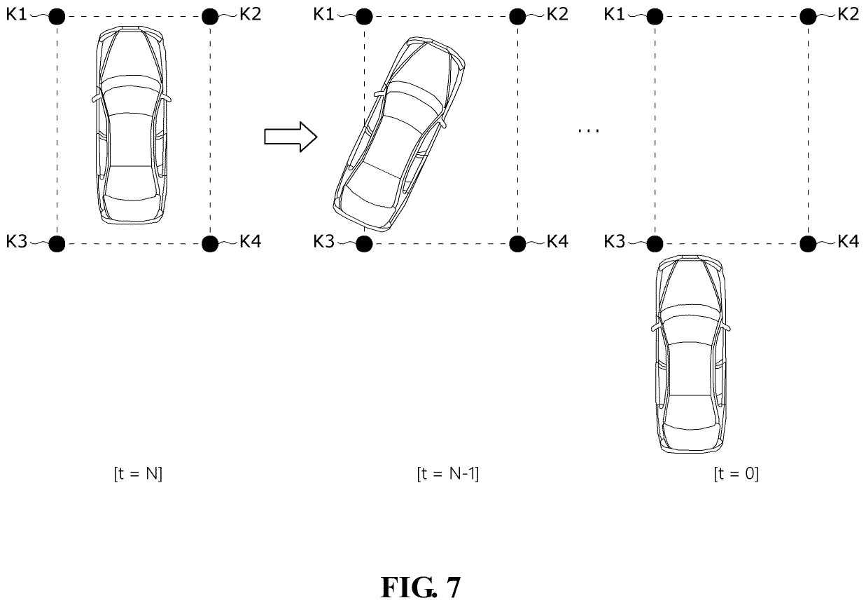

Referring to FIG. 4 together, the second processing unit 122 may generate base keypoints by applying the overall length and overall width of the vehicle. In other words, the second processing unit 122 may determine the base keypoints based on a length of the vehicle and/or the width of the vehicle. For example, when the overall length of the vehicle is L and the overall width is D, the second processing unit 122 may calculate points K1(−D/2, +L/2), K2(+D/2, +L/2), K3(−D/2,−L/2), and K4(+D/2,−D/2) as four keypoints with the point of origin of the vehicle (e.g., the point of origin at the center of the vehicle) as a reference point (0, 0).

The second processing unit 122 may calculate margin values using the second sensing data obtained from the ultrasonic sensor and correct the base keypoints using the margin values. A margin value may be a distance between the vehicle and one or more base keypoints in a given direction (e.g., further purpose of providing a buffer zone). The second processing unit 122 may determine a distance to an external object at the parking end time point using the second sensing data of the ultrasonic sensor. The second processing unit 122 may set the smaller value among a preset reference value and a value of the distance to the external object which is calculated using the second sensing data as the margin value and may apply the margin value to coordinates of the base keypoints.

For example, the second processing unit 122 may set the smaller value among a value of a distance to an object in the front and the reference value as a front margin value d1, set the smaller value among a value of a distance to an object in the rear and the reference value as a rear margin value d3, set the smaller value among a value of a distance to an object to the left and the reference value as a left margin value d4, and set the smaller value among a value of a distance to an object to the right and the reference value as a right margin value d2. For example, the reference value may be set to 0.5 m, but the present disclosure is not limited thereto, and the reference value may be set in various ways depending on the vehicle type, specifications, parking environment, etc.

The second processing unit 122 may correct the base keypoints by applying the above-described margin values to the base keypoints generated by applying the overall length and overall width of the vehicle. That is, the second processing unit 122 may apply the front margin value and the left margin value to the coordinates of the base keypoint K1, apply the front margin value and the right margin value to the coordinates of the base keypoint K2, apply the rear margin value and the left margin value to the coordinates of the base keypoint K3, and apply the rear margin value and the right margin value to the coordinates of the base keypoint K4.

Finally, the second processing unit 122 may calculate four keypoints, which are corrected using the points K1(−D/2+d4, +L/2+d1), K2(+D/2+d2, +L/2+d1), K3(−D/2+d4,−L/2+d3), and K4(+D/2+d2,−D/2+d3), as the base keypoints. Accordingly, a parking space that can secure a safe distance or a minimal safe distance to an external object may be defined, and base keypoints for the parking space may be generated.

In this case, the second processing unit 122 may generate 3-dimensional (3D) coordinates of the base keypoints by adding the height value of the ground to the corrected base keypoints. The second processing unit 122 may generate coordinates of the base keypoints that have coordinate values (X, Y, Z) by adding the height value of the ground to a Z axis using the road profile of the first processing unit 121.

Further, the second processing unit 122 may set offset values using difference values between the coordinates of the keypoint generated using the parking boundary lines in the regular parking space and the coordinates of the base keypoint generated.

FIG. 5 is a view for describing an operation of the second processing unit. Referring to FIG. 5, coordinates of reference keypoints P1 to P4 may be generated for vertexes where four parking boundary lines meet in a regular parking space. The coordinates of the reference keypoints P1 to P4 may be generated by identifying a parking space entrance line, a parking space exit line, and two side lines connecting the parking space entrance line and the parking space exit line in image data obtained from the camera and by using coordinates of the vertexes where the lines meet.

The second processing unit 122 may generate coordinates of base keypoints K1 to K4 according to the above-described process from the same image data obtained by photographing the regular parking space. In this case, there may be a difference between the coordinates of the reference keypoints P1 to P4 generated using the vertexes of the parking boundary lines and the coordinates of the base keypoints K1 to K4 generated using odometry.

For example, when coordinate values of one of the reference keypoints are (+10, +10, +10) and coordinate values of a corresponding base keypoint are (+9, +12, +10), difference values between the coordinates of the reference keypoints and the coordinates of the base keypoints may be calculated as (+1, −2, 0). The second processing unit 122 may set the calculated difference values as offset values and add the offset values to the coordinates of the base keypoints.

That is, the offset values may be gaps between keypoints for a virtual parking space that are generated when a driver or an autonomous vehicle actually parks and keypoints that are generated according to parking boundary lines. The second processing unit 122 may calculate the base keypoints by reflecting the offset values, thereby reducing the gaps between the keypoints for the virtual parking space and the keypoints generated according to the parking boundary lines.

The second processing unit 122 may correct the coordinates of the base keypoints by adding the calculated offset values to coordinates of base keypoints generated in another parking space.

The third processing unit 123 may generate keypoints for each frame using the reference points and the change in position of the vehicle. The third processing unit 123 may calculate (e.g., backtrack) the change in position of the vehicle for each frame in reverse (e.g., in reverse order in time) from the parking end time point, calculate a relative positional relationship between the base keypoints and the vehicle for each frame, and generate the keypoints for each frame based on the relative positional relationship.

Referring to FIGS. 6 and 7 together, the third processing unit 123 may calculate a positional relationship between a target parking space and the vehicle in a frame immediately before the parking end time point by inversely (e.g., retroactively, in reverse order, etc.) calculating the change in position of the vehicle a frame at the parking end time point t=N and a frame immediately before the parking end time point t=N−1. The third processing unit 123 may estimate positions of the base keypoints K1 to K4 in the frame immediately before the parking end time point based on the positional relationship between the target parking space and the vehicle.

For example, the third processing unit 123 may multiply the coordinates of the base keypoints at the parking end time point by the change in position of the vehicle from the frame at the parking end time point t=N to the frame immediately before the parking end time point t=N−1 to calculate the coordinates of the base keypoints in the previous frame as provided in the following Expression 2.

$${P}_{t - 1}^{w} = {[ RotMat \vert TlansVec ]}_{t \to t - 1} {P}_{t}^{w} \qquad [ Equation 2 ]$$

In Equation 2, Pₜ^{w} denotes coordinates [X, Y, Z] of the base keypoint at the time point t, Pₜ₋₁^{w} denotes the coordinates [X, Y, Z] of the base keypoint at the timepoint t−1, and [RotMat|Tlans Vec]_{t→t-1} denotes odometry between the time point t and the time point t−1. The odometry between the time point t and the time point t−1 may be calculated by inversely estimating the odometry from the time point t−1 to the time point t.

In this way, the third processing unit 123 may generate positions of the base keypoints K1 to K4 for all the frames in reverse order from the parking end time point t=N to the parking start time point t=0.

Although FIGS. 6 and 7 are described as conceptual diagrams in the form of a top view for convenience of description, keypoints may be generated on image data obtained from a front camera, side cameras, and a rear camera for each frame in actual camera image data.

It may be possible to generate keypoints for parking in an irregular parking space where parking space lines are not complete. For example, there may be only partial parking space lines (e.g., fewer than four lines for the four sides of a rectangle) or portions of the lines may have been erased or effaced. Further, when a process of training a deep learning model with respect to the generated keypoints is repeated or accumulated (e.g., over a long period of time and across multiple parking operations), there is a technical effect in that the keypoints may be automatically generated at the moment of entering the irregular parking space, and through this, parking assistance may be performed or an auto parking system may be implemented.

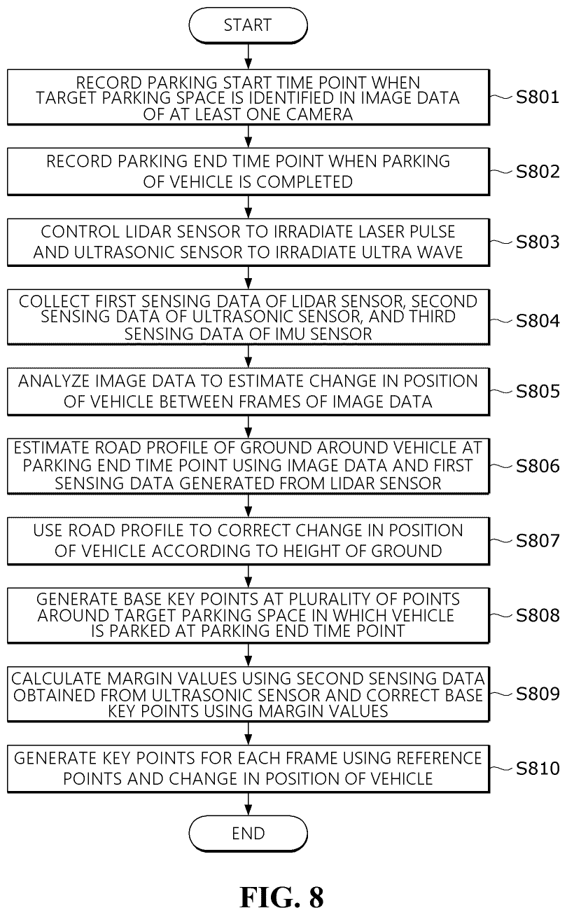

FIG. 8 is a flowchart of an example parking space detection method.

Referring to FIG. 8, a processor records a parking start time point when a target parking space is identified in image data of at least one camera (S801).

Next, the processor records a parking end time point when parking of a vehicle is completed (S802).

Next, the processor controls a lidar sensor to irradiate the ground of the target parking space with laser pulses by controlling the lidar sensor and controls an ultrasonic sensor to irradiate a front, sides, and a rear of the vehicle with ultrasonic waves by controlling the ultrasonic sensor (S803).

The control of the lidar sensor and the ultrasonic sensor may be performed simultaneously or sequentially.

Next, the processor collects sensing data through a communication unit. The processor receives image data that is obtained from the camera from the parking start time point to the parking end time point, first sensing data of the lidar sensor, and second sensing data of the ultrasonic sensor. Further, the processor receives third sensing data from an IMU sensor of the vehicle through the communication unit. In this case, only data measured at the parking end time point among the first sensing data and the second sensing data may be received (S804).

Next, the processor analyzes the image data to estimate a change in position of the vehicle between frames of the image data. The processor may estimate the change in position of the vehicle by calculating the movement of the vehicle between the frames of the image data. The processor may estimate the change in position of the vehicle for each frame of all the image data from a time point t=0, which is the parking start time point, to a time point t=T, which is the parking end time point (S805).

Next, the processor estimates a road profile of the ground around the vehicle at the parking end time point using the image data and the first sensing data generated from the lidar sensor. The processor may estimate the height of the ground around the target parking space using the image data and the first sensing data to generate the road profile (S806).

The processor may analyze data scanned by the lidar sensor to determine the condition of the ground on which the vehicle is traveling. When the parking end time point is recorded, a first processing unit may control the lidar sensor to irradiate the ground of the target parking space with the laser pulses, calculate a distance between the lidar sensor and the ground using detection information received from the radar sensor, and estimate the height of the ground using the calculated distance.

Next, the processor may use the road profile to correct the change in position of the vehicle according to the height of the ground (S807).

Next, the processor generates base keypoints at a plurality of points around the target parking space in which the vehicle is parked at the parking end time point. The processor generates the base keypoints by applying the overall length and overall width of the vehicle (S808).

The processor generates the base keypoints along a virtual shape surrounding the vehicle with the center of the vehicle as the point of origin. The processor generates the base keypoints at vertexes of the virtual shape.

Next, the processor may calculate margin values using the second sensing data obtained from an ultrasonic sensor and correct the base keypoints using the margin values. The processor determines a distance to an external object at the parking end time point using the second sensing data of the ultrasonic sensor. The processor sets the smaller value among a preset reference value and a value of the distance to the external object calculated using the second sensing data as the margin value and applies the margin value to coordinates of the base keypoints (S809).

Next, the processor generates keypoints for each frame using the reference points and the change in position of the vehicle. The processor calculates the change in position of the vehicle for each frame in reverse from the parking end time point, calculates a relative positional relationship between the base keypoints and the vehicle for each frame, and generates the keypoints for each frame based on the relative positional relationship (S810).

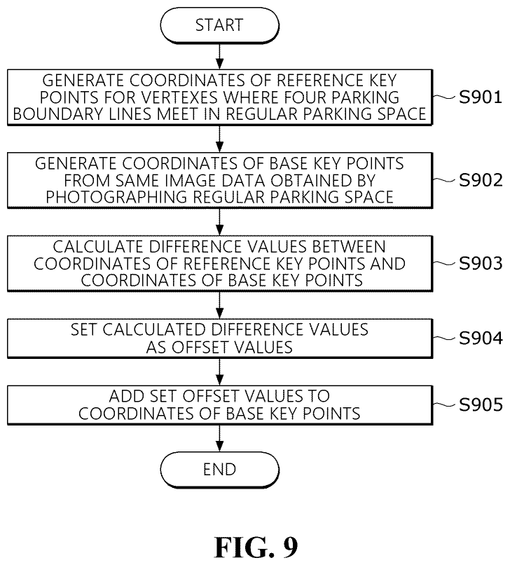

FIG. 9 is a flowchart for describing operations of an example second processing unit.

Referring to FIG. 9, the second processing unit generates coordinates of reference keypoints for vertexes where four parking boundary lines meet in the regular parking space. The coordinates of the reference keypoints may be generated by identifying a parking space entrance line, a parking space exit line, and two side lines connecting the parking space entrance line and the parking space exit line in image data obtained from the camera and by using coordinates of the vertexes where the lines meet (S901).

Next, the second processing unit generates coordinates of the base keypoints according to the above-described process from the same image data obtained by photographing the regular parking space (S902).

Next, the second processing unit calculates difference values between the coordinates of the reference keypoints and the coordinates of the base keypoints and sets the calculated difference values as offset values (S903 and S904).

Next, the second processing unit may add the set offset values to the coordinates of the base keypoints so that gaps between keypoints for a virtual parking space and the keypoints generated according to the parking boundary lines may be reduced (S905).

By using the parking space detection device and method, it is possible to automatically perform labeling on a parking space without parking lines.

Further, it is possible to improve the performance of labeling for a parking space with parking lines.

Terms described in the specification such as “unit” refer to a software or hardware component such as a FPGA or an ASIC, and the unit performs certain functions. However, the “unit” is not limited to software or hardware. The “unit” may be formed in a storage medium that may be addressed or may be executed by at least one processor. Therefore, examples of the “unit” include components, such as software components, object-oriented software components, class components, and task components, and processes, functions, attributes, procedures, subroutines, segments of program codes, drivers, firmware, micro codes, circuits, data, databases, data structures, tables, arrays, and variables. Components and functions provided from “units” may be combined into a smaller number of components and “units” or may be further separated into additional components and “units.” In addition, the components and the “units” may be implemented to operate one or more CPUs in a device or a secure multimedia card.

A parking space detection device may include one or more processors, and a memory configured to store one or more programs executed by the one or more processors, wherein the processor includes a first processing unit that analyzes image data of surrounding images of a vehicle captured by a camera between a parking start time point and a parking end time point and estimates a change in position of the vehicle between frames of the image data, a second processing unit that generates base keypoints at a plurality of points around a target parking space in which the vehicle is parked at the parking end time point, and a third processing unit that generates keypoints for each frame using the base keypoints and the change in position of the vehicle.

The third processing unit may calculate the change in position of the vehicle for each frame in reverse from the parking end time point, calculate a relative positional relationship between the base keypoints and the vehicle for each frame, and generate the keypoints for each frame based on the relative positional relationship.

The first processing unit may estimate the change in position of the vehicle using visual odometry (VO) or visual inertial odometry (VIO).

The first processing unit may estimate a road profile of the ground around the vehicle at the parking end time point using the image data and first sensing data generated from a lidar sensor.

The first processing unit may estimate a height of the ground around the target parking space using the image data and the first sensing data to generate the road profile.

The first processing unit may correct the change in position of the vehicle at the parking end time point using the road profile.

The second processing unit may generate the base keypoints along a virtual shape surrounding the vehicle with a center of the vehicle as the point of origin.

The second processing unit may generate the base keypoints at vertexes of the virtual shape.

The second processing unit may generate the base keypoints by applying an overall length and overall width of the vehicle.

The second processing unit may calculate margin values using second sensing data obtained from an ultrasonic sensor and correct the base keypoints using the margin values.

The parking start time point may be a time point at which the target parking space is photographed by at least one camera, and the parking end time point may be a time point at which the vehicle is completely arranged in the target parking space.

The target parking space may be a space with less than four boundary lines surrounding the parking space.

A parking space detection method, performed by a computing device including one or more processors and a memory configured to store one or more programs executed by the one or more processors, may include: analyzing image data of surrounding images of a vehicle captured by a camera between a parking start time point and a parking end time point and estimating a change in position of the vehicle between frames of the image data, generating base keypoints at a plurality of points around a target parking space in which the vehicle is parked at the parking end time point, and generating keypoints for each frame using the base keypoints and the change in position of the vehicle.

The generating of the keypoint for each frame may include calculating the change in position of the vehicle for each frame in reverse from the parking end time point, calculating a relative positional relationship between the base keypoints and the vehicle for each frame, and generating the keypoints for each frame based on the relative positional relationship.

The estimating of the change in position of the vehicle may include estimating a road profile of the ground around the vehicle at the parking end time point using the image data and first sensing data generated from a lidar sensor, and correcting the change in position of the vehicle at the parking end time point using the road profile.

In the estimating of the road profile, a height of the ground around the target parking space may be estimated using the image data and the first sensing data and thus the road profile may be generated.

In the generating of the base keypoints, the base keypoints may be generated along a virtual shape surrounding the vehicle with a center of the vehicle as the point of origin.

In the generating of the base keypoints, the base keypoints may be generated at vertexes of the virtual shape.

In the generating of the base keypoints, the base keypoints may be generated by applying an overall length and overall width of the vehicle.

The generating of the base keypoints may include calculating margin values using second sensing data obtained from an ultrasonic sensor and correcting the base keypoints using the margin values.

While example embodiments of the present disclosure and their advantages have been described above in detail, it should be understood by those skilled in the art that various changes, substitutions, and alterations may be made herein without departing from the scope of the disclosure as defined by the following claims.

What is claimed is:

1. A device comprising:
one or more processors; and
memory storing one or more instructions executable by the one or more processors to cause:
receiving image data representing an external environment of a vehicle, wherein the image data is generated, by at least one camera associated with the vehicle, between a first time, when the vehicle starts a parking operation, and a second time, when the vehicle ends the parking operation, and wherein the image data comprises a plurality of image frames;
determining, based on the plurality of image frames, a plurality of position changes of the vehicle, wherein each of the plurality of position changes is a respective estimated position change of the vehicle between two frames of the plurality of image frames;
determining one or more base keypoints for a target parking space, wherein the one or more base keypoints are associated with the second time at which the vehicle is parked in the target parking space;
determining, based on the one or more base keypoints and the plurality of position changes of the vehicle, one or more keypoints for the target parking space in each of the plurality of image frames; and
controlling, based on the one or more keypoints, an autonomous parking operation of the vehicle.

2. The device of claim 1, wherein the one or more instructions are executable by the one or more processors to cause the determining of the plurality of position changes of the vehicle by:
determining, for each frame of the plurality of image frames in reverse order from the second time to the first time, a relative positional relationship between the one or more base keypoints and the vehicle, and
wherein the one or more instructions are executable by the one or more processors to cause the determining of the one or more keypoints by:
determining, based on the relative positional relationship, the one or more keypoints in each of the plurality of image frames.

3. The device of claim 1, wherein the one or more instructions are executable by the one or more processors to cause the determining of the plurality of position changes by:
determining the plurality of position changes further based on at least one of visual odometry or visual inertial odometry.

4. The device of claim 1, wherein the one or more instructions are executable by the one or more processors to further cause:
determining, based on the image data and sensing data, a road profile of a ground around the vehicle, wherein the sensing data is generated, at the second time, by a lidar sensor.

5. The device of claim 4, wherein the one or more instructions are executable by the one or more processors to cause the determining of the road profile by:
determining, based on the image data and the sensing data, a relative height, relative to a first ground surface in the target parking space, of a second ground surface outside the target parking space.

6. The device of claim 4, wherein the one or more instructions are executable by the one or more processors to further cause:
adjusting, based on the road profile, a position change, of the plurality of position changes, that is associated with the second time.

7. The device of claim 1, wherein the one or more instructions are executable by the one or more processors to cause the determining of the one or more base keypoints by:
determining the one or more base keypoints along a virtual shape surrounding the vehicle, the virtual shape having a point of origin at a center of the vehicle.

8. The device of claim 7, wherein the one or more instructions are executable by the one or more processors to cause the determining of the one or more base keypoints by:
determining the one or more base keypoints at vertexes of the virtual shape.

9. The device of claim 1, wherein the one or more instructions are executable by the one or more processors to cause the determining of the one or more base keypoints by:
determining the one or more base keypoints further based on at least one of a length of the vehicle and a width of the vehicle.

10. The device of claim 1, wherein the one or more instructions are executable by the one or more processors to further cause:
determining, based on sensing data received from an ultrasonic sensor, margin values; and
adjusting, based on the margin values, the one or more base keypoints.

11. The device of claim 1, wherein, at the first time, the target parking space is photographed by the at least one camera, and
wherein, at the second time, the vehicle is located in and aligned to the target parking space.

12. The device of claim 1, wherein the target parking space has less than four boundary lines.

13. A method performed by a computing device of a vehicle, the method comprising:
receiving image data representing an external environment of the vehicle, wherein the image data is generated, by at least one camera associated with the vehicle, between a first time, when the vehicle starts a parking operation, and a second time, when the vehicle ends the parking operation, and wherein the image data comprises a plurality of image frames;
determining, based on the plurality of image frames, a plurality of position changes of the vehicle, wherein each of the plurality of position changes is a respective estimated position change of the vehicle between two frames of the plurality of image frames;
determining one or more base keypoints for a target parking space, wherein the one or more base keypoints are associated with the second time at which the vehicle is parked in the target parking space;
determining, based on the one or more base keypoints and the plurality of position changes of the vehicle, one or more keypoints for the target parking space in each of the plurality of image frames; and
controlling, based on the one or more keypoints, an autonomous parking operation of the vehicle.

14. The method of claim 13, wherein the determining of the plurality of position changes of the vehicle comprises:
determining, for each frame of the plurality of image frames in reverse order from the second time to the first time, a relative positional relationship between the one or more base keypoints and the vehicle, and
wherein the determining of the one or more keypoints comprise:
determining, based on the relative positional relationship, the one or more keypoints in each of the plurality of image frames.

15. The method of claim 13, further comprising:
determining, based on the image data and sensing data, a road profile of a ground around the vehicle, wherein the sensing data is generated, at the second time, by a lidar sensor; and
adjusting, based on the road profile, a position change, of the plurality of position changes, that is associated with the second time.

16. The method of claim 15, the determining of the road profile comprises:
determining, based on the image data and the sensing data, a relative height, relative to a first ground surface in the target parking space, of a second ground surface outside the target parking space.

17. The method of claim 13, wherein the determining of the one or more base keypoints comprises:
determining the one or more base keypoints along a virtual shape surrounding the vehicle, the virtual shape having a point of origin at a center of the vehicle.

18. The method of claim 17, wherein the determining of the one or more base keypoints comprises:
determining the one or more base keypoints at vertexes of the virtual shape.

19. The method of claim 18, wherein the determining of the one or more base keypoints comprises:
determining the one or more base keypoints further based on at least one of a length of the vehicle and a width of the vehicle.

20. The method of claim 19, further comprising:
determining, based on sensing data received from an ultrasonic sensor, margin values; and
adjusting, based on the margin values, the one or more base keypoints.
